(19) United States
(12) Patent Application Publication
(10) Pub. No.: US 2010/0114709 A1
(43) Pub. Date: May 6, 2010

(54) REAL-TIME DISTRIBUTION OF TARGETED ADVERTISEMENT AND SPONSORED CONTENT

(75) Inventors: Athellina Athsani, San Hose, CA (US); Marc Davis, San Francisco, CA (US); Marco Boerries, Los Altos, CA (US); Chris Kalaboukis, Los Gatos, CA (US); Joseph O'Sullivan, Sunnyvale, CA (US); Chris W. Higgins, Portland, OR (US); Christopher T. Paretti, Sunnyvale, CA (US); Edward Stanley Ott, IV, Sunnyvale, CA (US); Irfan Presswala, Sunnyvale, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/264,479

(22) Filed: Nov. 4, 2008

(51) Int. Cl. G06Q 30/00

(52) U.S. Cl. 705/14.64; 705/14.66

(57) ABSTRACT

A method and system for serving advertisement or sponsored content information is provided. The method employed by the system may include receiving information that describes the capabilities of an ad serving device, receiving information that enables sensing the presence of individuals in a vicinity of the ad serving device, matching advertisement and/or sponsored content information to the ad serving device, and serving the advertisement and/or sponsored content information. Receiving presence information, matching, and serving of the advertisement and/or sponsored content information may occur in real-time. The ad serving device may be located at a fixed location or be portable and carried by an individual. Behaviors of individuals with portable devices may be determined and the advertisement and/or sponsored content information served may be related to the determined behavior.

### BACKGROUND

Advertising has always been a powerful way for manufacturers or service providers to sell goods and services. In the past, advertisements were taken out in newspapers and magazines. Thereafter, advertisements were taken out on radio and then television, with the advent of those technologies. Today, the Internet has emerged as a powerful advertising medium. For example, it is commonplace to see advertisements on many websites, such as search websites or news websites.

Historically speaking, with the advent of each new medium, advertisers were able to target more and more selective audiences. For example, with radio and television, an advertiser could assume a certain audience based on the programming content and target an advertisement accordingly. Today, the Internet enables even more precise targeting. For example, advertisements can be targeted based on key words specified by a searcher via a search website or based on the content of a website.

As the number of websites and web pages have increased, so too have the number of advertisers and their number of associated ad copy for relevant target audience or demographic. As the number of online users increases, the ways in which users are exposed to information grow and change. Many display devices exist around users and may display static or billboard-type advertisements

However, there is no way to instrument the mobile and external display devices or appliances in our environments, so the potential opportunity to connect consumers to commercial information and to connect advertisers to users through third-party or independent display owners is not realized.

The advertising mediums described above have their limitations as well. For example, radio and television advertising, while good for broadcasting to large audiences, is not as targeted as Internet based advertising. Moreover, the amount of advertising time available is limited by the need to broadcast non-advertising content. On the other hand, Internet search based advertising requires active participation on the part of a user at a terminal. For example, an Internet user needs to be sitting in front of a terminal searching with key words or navigating to a web site.

### BRIEF DESCRIPTION OF THE DRAWINGS

FIG. 1 illustrates an ad serving system serving advisements to ad serving devices;

FIG. 2A illustrates several examples of ad serving devices;

FIG. 2B depicts a sports bar with a large display that serves as an ad serving device;

FIG. 2C depicts a scenario in which a single advertisement is distributed across several ad serving devices;

FIG. 2D depicts a scenario in which the advertisement and/or sponsored content is distributed between ad serving devices with different capabilities;

FIG. 3 depicts several examples of trackable devices;

FIG. 4 depicts examples of proxy devices;

FIG. 5 is a flow diagram for serving advertisement and/or sponsored content to the ad serving system;

FIG. 6 is a flow diagram for serving advertisement and/or sponsored content via a proxy device;

FIG. 7 is a flow diagram for serving advertisement and/or sponsored content to portable ad serving devices;

FIG. 8 is a flow diagram for enabling an owner of an ad serving device to register the ad serving device;

FIG. 9 is a flow diagram for enabling an advertiser to place advertisements on ad serving devices; and

FIG. 10 illustrates a general computer system, which may represent any of the computing devices referenced herein.

### DETAILED DESCRIPTION OF THE DRAWINGS AND THE PRESENTLY PREFERRED EMBODIMENTS

Systems and methods of serving advertisements or sponsored content are disclosed: that match and serve ads and display devices in real-time based upon the presence information and characteristics, profiles and any rankings of users present, co-present and within the vicinity of one or more display devices, including means for registering a plurality of display devices, either separate or in coordinated display to enable advertisers to target not only times and places frequented by users but also to target the association of users and/or the activities of the users in real time and space.

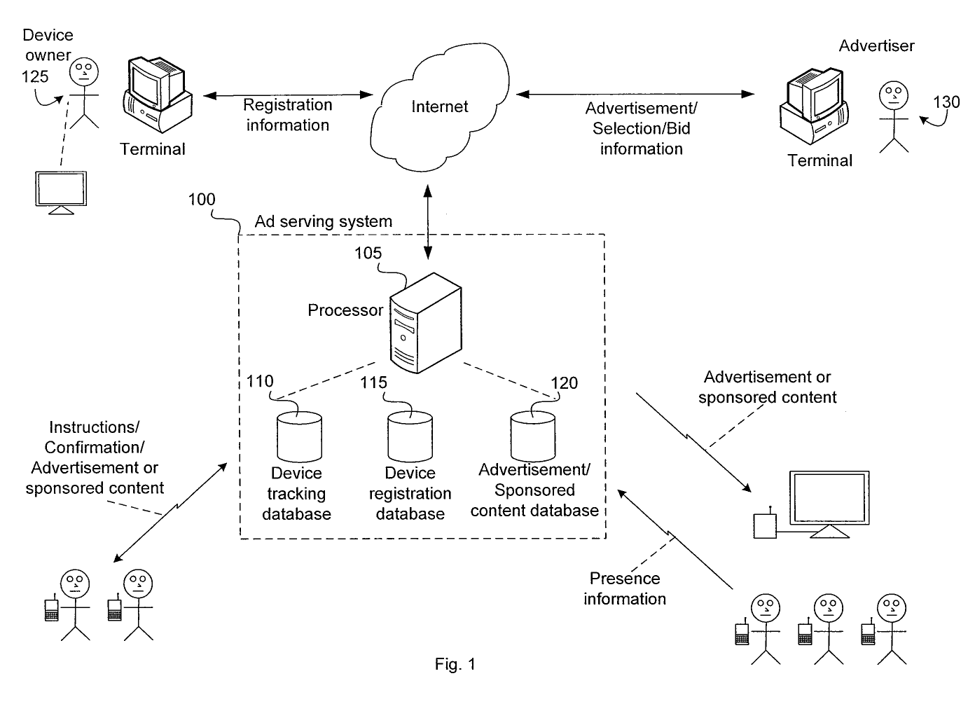

FIG. 1 illustrates an ad serving system 100 serving advisements to ad serving devices. The ad serving system 100 includes a processor 105, a tracking database 110, a device registration database 115, and an advertisement/sponsored content database 120.

The processor 105 may be implemented using any conventional computer or other data processing device, such as an Intel®, AMD®, or PowerPC® based computer operating a Microsoft Windows®, Linux, or other Unix® based operating system. The processor 105 may include networking hardware that enables communicating with equipment residing outside of the ad serving system 100 via a network protocol, such as an Internet protocol. In this respect, the processor 105 may include software, such as Apache® or Microsoft Internet Information Server®, that enables communicating web pages to device owner terminals 125 and advertiser terminals 130. The device tracking database 110, device registration database 115, and advertisement/sponsored content database 120 may reside within the processor 105 and may enable storing information related to the operation of the ad serving system 100. Alternatively, the databases may reside within different processors, which may be in communication with the processor 105 via, for example, a network interface.

The device registration database 115 is utilized to store information associated with ad serving devices, trackable devices, and/or proxy devices as defined below including the economic terms associated with the display device across its range of possible ad serving capabilities. The information stored may include data that defines characteristics and capabilities of the respective devices. For example, in the case of an ad serving device, the data may define whether the ad serving device supports graphics and/or video and audio capabilities along with data that defines the dimensions and viewing environments of each, such as the size and resolution of a display on the ad serving device. Other information, such as whether the ad serving device is portable or fixed, private or publicly-viewable, personal or shared among more than one user may be stored as well. In the case of a fixed ad serving device, the location of the ad serving device may be specified, and in the case of mobile devices a range of expected locations, means of transportation and association can be built by tracking the display device over time in relation to all known users or other devices on the network.

Data for defining communication capabilities may also be stored. For example, the name of a network carrier associated with the devices and whether the devices include secondary network capabilities, such as Bluetooth®, which is a wireless protocol utilizing short-range communications technology for facilitating data transmission over short distances from fixed and/or portable devices. A unique ID associated with either or both the network carrier and the secondary network may be stored and utilized to distinguish devices from one another and/or associate the devices with a specific individual.

The information stored in the registration database 115 may also include information that enables identifying the owner of the device. For example, the name and address of the owner may be stored. The information may also include economic terms associated with the placement of advertisements or sponsored content on the ad serving device. For example, a given owner may specify a money amount associated with placing an advertisement or sponsored content on his ad serving device. Economic terms for the display device can be fixed or variable, monetary or non-monetary and subject only to the delivery and display on device or alternatively subject to further follow on action by the display device owner or the target as agreed between display device owners and advertisers including fixed Cost Per iMpression (CPM), Cost Per Click (CPC) and Cost Per Action (CPA).

The device tracking database 110 is utilized to store real-time tracking information that enables determining the location of a trackable device and, accordingly, the location of an individual carrying the trackable device. The location may be determined in several ways. In one embodiment, the trackable device includes GPS circuitry that enables communicating, for example, a latitude and longitude of the trackable device to the ad serving system 100. In a second embodiment, the location may be determined via a carrier network associated with the trackable device. For example, the location of the trackable device may be determined by triangulation of signals communicated between the trackable device and radio communication towers operating within the carrier network. Local networks such as WiFi and Bluetooth are also capable of providing location corroboration data for users and co-present users.

In a third embodiment, the location of the trackable device is determined when it comes within the vicinity of an ad serving device of known location. This is the case for a trackable device adapted to communicate with ad serving devices via a secondary communication network, such as Bluetooth. In this case, unique identifying data from the trackable device may be communicated via the secondary network to the ad serving device, which in turn may relay the unique identifying data to the ad serving system 100. In some cases, the identifying data is associated with a particular individual. The unique identifying data enables the ad serving system 100 to infer that the location of the trackable device is the same as the location of the ad serving device. The unique identifying data may correspond to a unique media access control (MAC) address associated with the trackable device. The MAC address is a quasi-unique identifier assigned to most networking equipment.

A timestamp may be associated with the location information. The timestamp facilitates tracking the location of the trackable device throughout the day and, therefore, the individual in possession of the trackable device. The location and timestamp information enables determining characteristics and behaviors of the individual in possession of the trackable device. This in turn enables serving targeted advertisement and/or sponsored content to the individual in possession of the trackable device. For example, knowledge that the individual frequents coffee houses may be utilized to infer that the individual is a coffee lover. In this example, the ad serving system 100 may serve a coffee advertisement to ad serving devices in the vicinity of the individual when the individual is sensed within the vicinity of those ad serving devices. At least one advantage of this approach is that it is more likely to result in a conversion or sale of the product being advertised. Timestamps may also be used to determine users relative overlap in locations with each other and to consider this association data as part of the targeting of advertisements for display on devices in real places with a known set of associated or within the vicinity users. Timestamps may also be combined with other environmental sensors, such as motion sensors to determine a user goes jogging every morning and use that data to help target advertisements to displays in their environment and/or upon their own personal or shared display devices.

The advertisement/sponsored content database 120 is utilized to store information associated with advertisements and/or sponsored content to be placed on ad serving devices including ad copy and any targeting or demographic information. The sponsored content may correspond to an exclusive audio and/or video file, such as the latest single from a popular musician. In one embodiment, the actual data that defines the advertisement and/or sponsored content may be stored. For example, data defining text, graphics, video, and audio information may be stored. In other embodiments, links to other databases with the advertisement and/or sponsored content may be provided. For example, a link to a different computer, such as a media server may be provided.

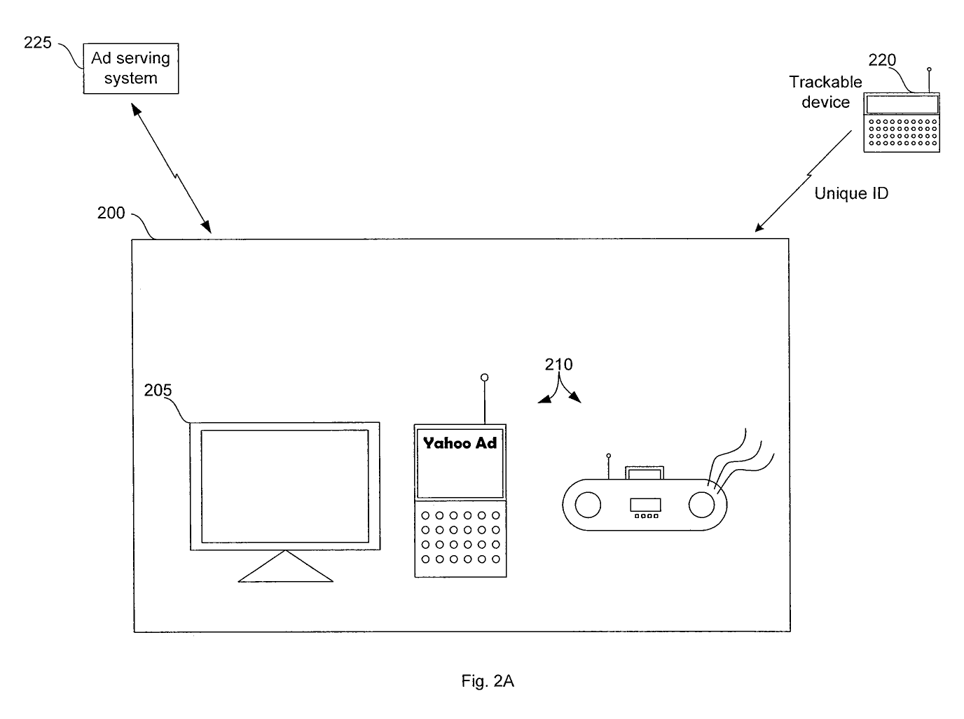

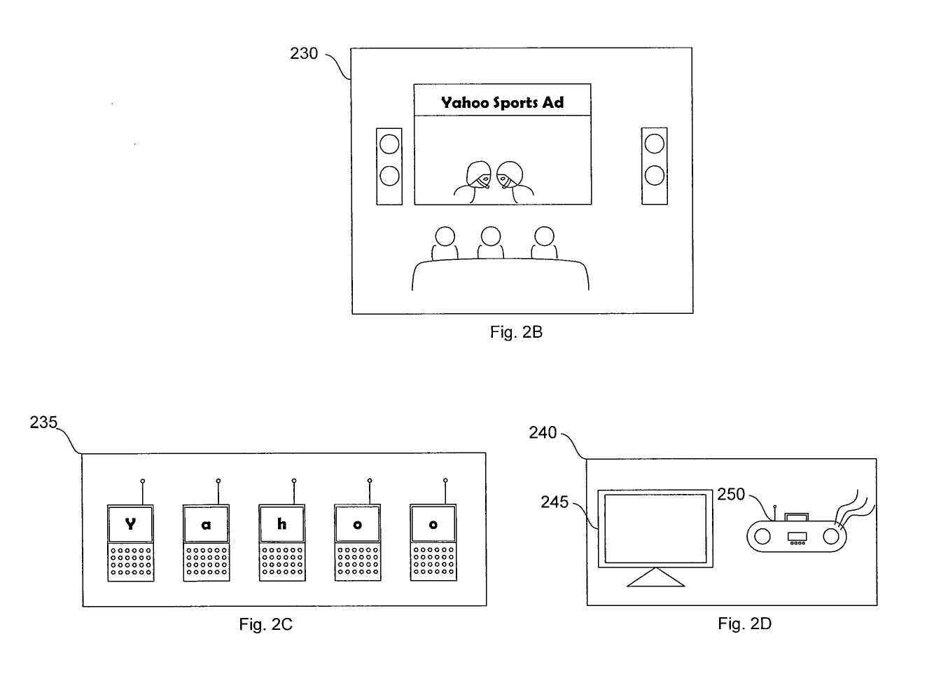

FIGS. 2A-4 describe the functionality of ad serving devices, tracking devices, and proxy devices that are utilized in conjunction with the ad serving system 100 of FIG. 1. Although described separately, the functionality for each may reside within a single device. For example, a cellular phone with graphics, GPS, Bluetooth capabilities, and a camera may be capable of performing the functions associated with the ad serving device, trackable device, sensor device and/or proxy device.

FIG. 2A illustrates several examples of ad serving devices 200. The examples include a stationary ad serving device 205, and portable ad serving devices and appliance 210. Ad serving devices 200 may include logic, code, and/or circuitry that enables conveying advertisement and/or sponsored content communicated from an ad serving system 225, which may correspond to the ad serving system 100 of FIG. 1. For example, the ad serving devices 200 may include networking hardware and software that enables communicating the information between the ad serving system 225 and the ad serving devices 200 over a network. The network may be wired or wireless. The information may include data defining graphics and/or audio information associated with an advertisement and/or sponsored content.

The ad serving devices 200 may also include logic, code, and/or circuitry that enables sensing the presence of trackable devices 220 within the vicinity of the ad serving devices 200. For example, the ad serving devices 200 may be adapted to communicate with a trackable device 220 via a secondary network, such as Bluetooth, when the trackable device 220 is within the vicinity of the ad serving devices 200. In doing so, a unique ID, such as a MAC address, may be communicated from the trackable device 220 to the ad serving devices 200. The ad serving devices 200 may then communicate the unique ID to the ad serving system 225 via the networking hardware described above. This in turn enables the ad serving system 225 to determine that the trackable device 220 is within the vicinity of the ad serving devices 200, which in turn enables determining the location of the trackable device 220 provided that the location of the ad serving devices 200 are known.

The stationary ad serving device 205 corresponds to a display and/or audio device capable of serving graphics and/or audio based advertisement and/or sponsored content. The stationary ad serving device 205 is stationary in the sense that the device is generally kept in the same location or is mounted or affixed to a physical location or building. For example, the stationary ad serving device 205 may correspond to a display and/or audio device placed on a counter of a coffee house or in a window, an electronic billboard, a display device in a bathroom, waiting room, elevator or other public or gender-segregated space. The stationary ad serving device 205 may also correspond to a billboard on the side of the road with a dynamic display.

The portable ad serving devices 210 correspond to portable devices with graphics and/or audio capabilities for conveying advertisement and/or sponsored content. For example, the portable ad serving devices 210 may correspond to cellular telephones, PDAs, or audio boom boxes. These devices are portable in the sense that they are meant to be moved from place to place.

FIGS. 2B-2D depict several ways in which the ad serving devices described above may be utilized to serve advertisement and/or sponsored content. FIG. 2B depicts a sports bar 230 with a large display that serves as an ad serving device. The display may include networking hardware for communicating with an ad serving system, such as the ad serving system 225 of FIG. 2 described above, and may be adapted to detect the presence of individuals within its vicinity as described above. During registration, the owner of the sports bar 230 may have indicated that the display was located in a sports bar. In this case, the ad serving system 225 may serve related advertisement and/or sponsored content to the display, such as sports related advertisements. Alternatively, the ad serving system 225 may serve ads based on the characteristics and behaviors of individuals sensed within the vicinity of the display.

FIG. 2C depicts a scenario in which a single advertisement is distributed across several ad serving devices 235. In this case, the ad serving devices 235 correspond to portable devices, such as cellular telephones or PDA devices. To facilitate distribution of the advertisement and/or sponsored content, instructions may be communicated from the ad serving system 225 to the owners of the ad serving devices 235 instructing them, for example, to go to a specified location at a specified time. The instructions may also direct the individuals to arrange themselves in a specified order. For example, one individual may be instructed to stand to the left of another individual. Upon receiving confirmation that the individuals are at the specified location at the specified time, the advertisement and/or sponsored content may be served. This may enable displaying an advertisement, such as the Yahoo! advertisement shown in FIG. 2C.

In addition or alternatively, the instructions may direct the individuals to position themselves in relation to a known object, location or device. The known object may be stationary or mobile. For example, three individuals with ad serving devices 235 may be instructed to position themselves around a local radio station music van located at a college campus. Once at the instructed location, sponsored content related to an upcoming concert may be served on the ad serving devices 235 carried by the individuals. In return for displaying the sponsored content, the individuals may be provided with discount coupons for the music concert.

Alternatively, the ad serving system 225 may locate ad serving devices 235 that are at a desired location at the same time via one of the techniques described above and then serve the advertisement and/or sponsored content to the located ad serving devices.

FIG. 2D depicts a scenario in which the advertisement and/or sponsored content is distributed between ad serving devices with different capabilities 240. Shown is an ad serving device with display capabilities 245, and an ad serving device with audio capabilities 250. In this case, the ad serving system 225 may serve a graphical portion of an advertisement to the ad serving device with display capabilities 245 and an audio portion of an advertisement to the ad serving device with audio capabilities 250.

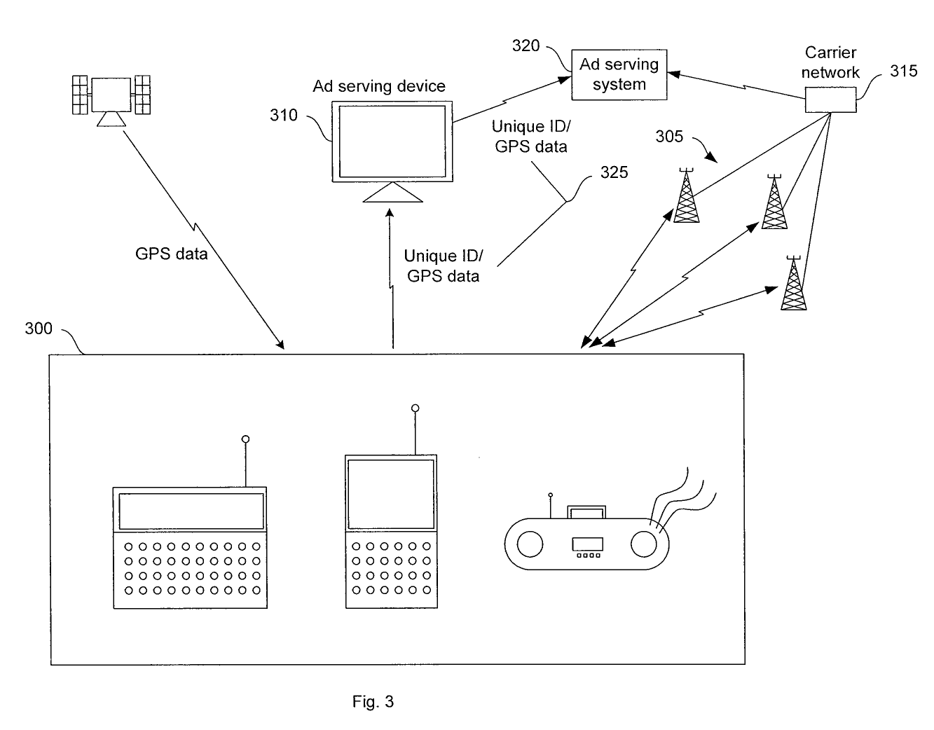

FIG. 3 depicts several examples of trackable devices 300. As noted above, a trackable devices 300 may also include the functionality of the ad serving devices described above, and/or proxy devices described in more detail below. Trackable devices 300 include logic, code, and/or circuitry that enables determining a location of an individual in possession of the trackable device 300. Trackable devices 300 may themselves also serve as sensors to aid in the tracking of other user's trackable devices 300.

In one embodiment, trackable devices 300 include GPS circuitry that enables communicating, for example, a latitude and longitude corresponding to the location of the trackable devices 300. For example, the latitude and longitude may be communicated to an ad serving system 320, which may correspond to the ad serving system 100 of FIG. 1. The trackable devices 300 may communicate the GPS related data directly to the ad serving system 320 or the data may be routed to the ad serving system 320 via an ad serving device 310, which may correspond to the ad serving devices 200 of FIG. 2A. For example, the GPS information may be communicated via Bluetooth to an ad serving device 310 in the vicinity of the trackable devices 300, and then the ad serving device 310 may relay the GPS information to the ad serving system 320.

In a second embodiment, the location may be determined via a carrier network 315 associated with the trackable devices 300. For example, the location of the trackable devices 300 may be determined by triangulation of signals communicated between the trackable devices 300 and radio communication towers 305 operating within the carrier network 315. The carrier network 315 may communicate the location information to the trackable devices 300, which in turn may communicate the information to the ad serving system 320. Alternatively, the carrier network 315 may communicate the location information directly to the ad serving system 320.

In a third embodiment, the locations of the trackable devices 300 may be determined when they come within the vicinity of an ad serving device 310. In this case, the trackable devices 300 communicate with the ad serving device 310 via a secondary communication network, such as Bluetooth. Unique identifying data 325 from the trackable devices 300 may be communicated via the secondary network to the ad serving device 310, which in turn may relay the unique identifying data 325 to the ad serving system 320. For example, a unique MAC address associated with each of the trackable devices 300 may be communicated. In some cases, the identifying data is associated with a particular individual.

A timestamp may be associated with the location information. The timestamp facilitates tracking the location of the trackable devices 300 throughout the day and, therefore, the individuals in possession of the trackable devices 300. The location and timestamp information enables determining characteristics and behaviors of the individual in possession of the trackable devices 300. This in turn enables serving targeted advertisement and/or sponsored content to the individuals in possession of the trackable devices 300. For example, knowledge that an individual frequents coffee houses may be utilized to infer that the individual is a coffee lover. In this example, the ad serving system 320 may serve a coffee advertisement to the ad serving device 310 when the individual's trackable device and, therefore, the individual, is sensed within the vicinity of the ad serving device 310. At least one advantage of this approach is that it is more likely to result in a conversion or sale of the product being advertised.

As noted above, trackable devices 300 may include unique identifying information that enables distinguishing between trackable devices 300. For example, a cellular device utilized as a trackable device may have a unique cellular number, such as an IMEI number, which is a unique number assigned to every GSM and UMTS mobile phone. Trackable devices 300 with Bluetooth capabilities may have a unique Bluetooth MAC address. The identifying information may be communicated along with the location information of the trackable devices 300 to the ad serving system 320, as described above. The ad serving system 320 may utilize this information to determine characteristics and behaviors of individuals in possession of the trackable devices 300. For example, knowledge that a trackable device was in several dance clubs during a given period may be utilized by the ad serving system 320 to infer that the individual in possession of the trackable device enjoys dance clubs. Upon detecting the same trackable device near an ad serving device 310, the ad serving system 320 may target suitable advertisement or sponsored content to the individual. For example, an advertisement for a new dance club may be displayed on ad serving devices within the vicinity of the trackable device.

In some instances, the identities and detailed behavioral information about individuals in possession of the trackable devices 300 may be known. For example, the individuals may have registered the trackable devices 300 with the ad serving system 320. The same individuals may have registered for an online Internet account where their respective browsing preferences may have been tracked. This additional information may enable the ad serving system 320 to provide even higher quality targeting, that is, targeting of ads more likely to produce a conversion or sale.

In one embodiment, the advertisement and/or sponsored content served to an ad serving device 310 may be based on the sensed presence of individuals of known relatedness within the vicinity of an ad serving device 310. For example, a husband and wife that carry separate trackable devices 300 may be sensed within the vicinity of the ad serving device 310. In this case, the ad serving system 320 may serve advertisement and/or sponsored content to the ad serving device 310 based on the known relatedness of the individuals. For example, an advertisement for vacation getaways may be served to a married couple.

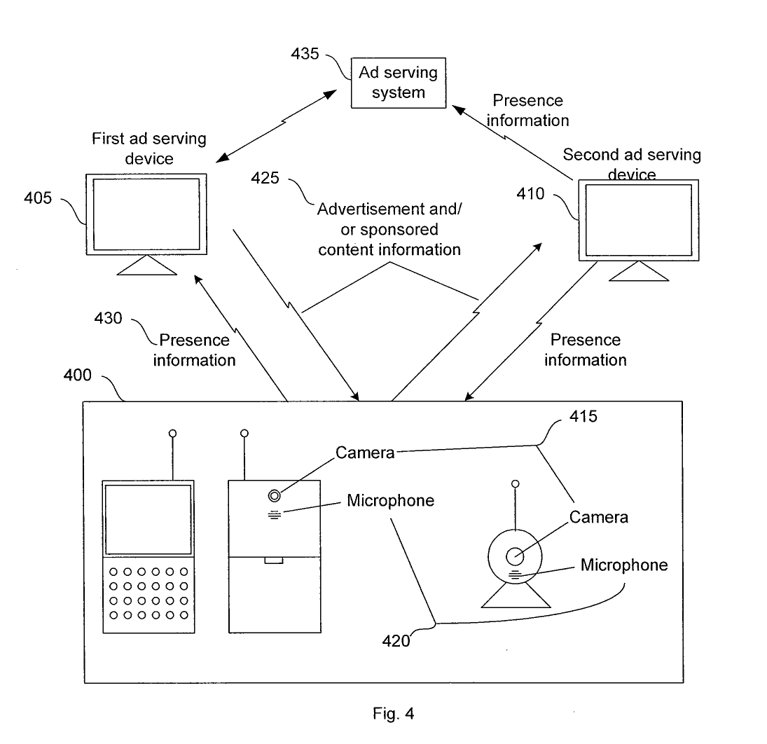

FIG. 4 depicts examples of proxy devices 400. As noted above, proxy devices 400 may also include the functionality of the ad serving devices and/or tracking devices described above. Proxy devices 400 include logic, code, and/or circuitry that enables relaying advertisement and/or sponsored content 425 from a first ad serving device 405 to a second ad serving device 410 in either real-time or at a later time. For example, the proxy devices 400 may include networking hardware and/or software that enables communicating data to and from the first ad serving device 405 and second ad serving device 410 over a network. The network may correspond to a wired or wireless network, such as a cellular, Bluetooth, or WIFI network. A camera 415 and/or microphone 420 may also be provided for capturing graphics and/or audio advertisement and/or sponsored content served via the first ad serving device 405. Hardware and/or software for recording the captured information may also be provided. For example, a memory card, such as an SD card or compact flash card, may be included for storing the captured information. Proxy devices 400 may also contain additional sensors useful to the system for gathering data about users, their activities and/or their environment including temperature or motion sensors, biometric sensors for picking up user's bio signals or other sensors used to determine whom is present and what they are currently doing with or near the proxy devices 400.

In operation, advertisement and/or sponsored content 425 is communicated to the proxy device 400 from the first ad serving device 405. The advertisement and/or sponsored content 425 may be communicated via the network or via a camera 415 and/or microphone 420. For example, data that defines the advertisement and/or sponsored content 425 may be communicated to the proxy devices 400 via the network. The advertisement and/or sponsored content 425 may also be captured by a camera and/or microphone if present on the proxy devices 400. For example, an individual in possession of a proxy device may hold the proxy device up towards the first ad serving device 405, which may be displaying an advertisement, and then begin recording the advertisement information conveyed. Identification information for identifying the advertisement and/or sponsored content may be captured along with the advertisement and/or sponsored content 425.

After the advertisement and/or sponsored content 425 is captured, the proxy device 400 communicates the captured information in real-time or a later time to a second ad serving device 410. For example, the advertisement and/or sponsored content 425 may be streamed to the second ad serving device 410 or communicated at a later time through, for example, email or as an SMS message. This may also be accomplished via the networks described above. The second ad serving device 410 may then serve the advertisement and/or sponsored content communicated as described with reference to FIG. 2 above. For example, the second ad serving device 410 may display advertisement and/or sponsored content 425 to individuals in the vicinity of the second ad serving device 410 and communicate presence information 430 back to an ad serving system 435, which may correspond to the ad serving system 100 of FIG. 1. The presence information 430 may be communicated directly to the ad serving system 435 or relayed through proxy devices 400 to the ad serving system 435.

In one embodiment, proxy devices 400 may be adapted to transcode the data communicated from the first ad serving device 405 to a format suitable for the second ad serving device 410. For example, proxy devices 400 may communicate data that defines the text of an advertisement to a second ad serving device 410 with only text capabilities. Alternatively, proxy devices 400 may convert the data that defines the text to speech utilizing a text to speech algorithm. The converted data may then be conveyed to a second ad serving device 410 with audio only capabilities. As another example, an image of an advertisement may be captured via the camera, converted to text via an optical character recognition algorithm (OCR), and communicated to a second ad serving device 410 that only supports simple text display, such as a ticker type of display.

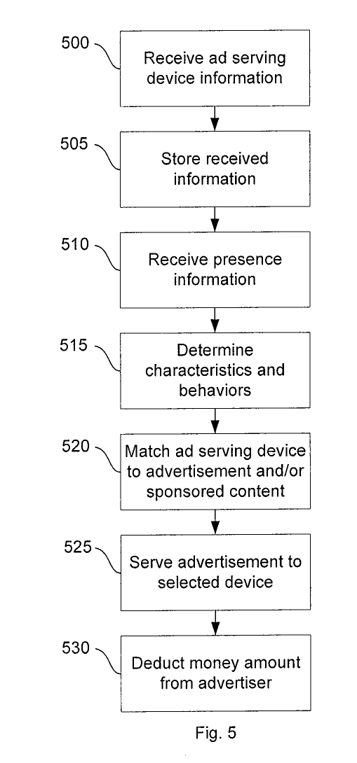

FIGS. 5-9 are flow diagrams that describe several operations of the ad serving system 100 of FIG. 1. FIG. 5 is a flow diagram for serving advertisement and/or sponsored content to the ad serving system 100. At block 500, information related to an ad serving device may be received. For example, a registration web page (not shown) may be provided by the ad serving system 100 and accessed by the owner of an ad serving device via an ad serving device owner terminal 125. The web page may include fields that enable specifying the information. The information may include ad serving device capabilities, such as display, audio, and location tracking capabilities as well as the desired or offered economic terms associated with each display device and ad copy combination offered by the system. Secondary network device capabilities may also be specified, such as whether the ad serving device includes Bluetooth capabilities or the capability to produce printed copies of advertisements or coupons. For stationary ad serving devices, the location of the stationary ad serving device may be specified. For portable ad serving devices, information such as the name of a network carrier associated with the portable ad serving device may be specified including a recent or complete history of the devices movements. Information that enables conducting monetary transactions may also be specified. For example, the name and address of the owner, bank account or credit card information and economic terms associated with providing advertisements or sponsored content on the ad serving device, may be specified.

At block 505, the information received may be stored. For example, received information may be stored in the device registration database 115.

At block 510, presence information corresponding to the sensed presence of individuals in the vicinity of an ad serving device may be received. For example, an ad serving device may detect a Bluetooth signal from a nearby trackable device, determine the MAC address associated with the trackable device, and communicate the unique MAC address to the ad serving system 100. Alternatively, the presence information may be communicated directly from the trackable device to the ad serving system 100 or from a network carrier associated with the trackable device to the ad serving system 100. For example, the trackable device may communicate GPS location data to the ad serving system 100, or the carrier network operator may, via triangulation, communicate the location of the trackable device to the ad serving system 100, as described with reference to FIG. 3 above. One GPS and Bluetooth-enabled user or device can provide presence information for other Bluetooth-sensed but not GPS-enabled devices since the system knows the location of the first user and the relative proximity of the other users based upon the limitations of Bluetooth.

This information, along with a timestamp, may be stored in the device tracking database 110 and utilized to determine characteristics and behaviors associated with the individual in possession of the trackable device or co-present devices or users. In some instances, the identity of the owner of the trackable device may be known and behaviors and characteristics determined through other means, such as the individual's user profile, rating, search histories, web surfing histories and offline and online shopping habits such as credit card purchases. Data on users may come from the user, the network or other third-party sources and may include analysis of actual communications among users including telephonic conversations, email, text or video conferencing.

At block 515, characteristics and behaviors associated with the individual in possession of the trackable device may be determined and stored. For example, a unique ID such as a cellular IMEI or Bluetooth Mac address may be utilized to distinguish among trackable devices in the vicinity of an ad serving device and enable tracking the movements of the trackable device and thereby determine the behaviors and characteristics of the individual in possession of the trackable device. For example, if the trackable device is frequently located in coffee houses, then the ad serving system 100 may ascertain that the individual in possession of the trackable device enjoys coffee. This will enable more effective targeting of ads. The effectiveness can be increased further where the identity of the individual is known along with, for example, his web browsing, searching and transaction habits. For example, Internet related shopping habits of the individual may be known and, therefore, utilized to enhance advertisement and/or sponsored content targeting.

At block 520, previously stored advertisement and/or sponsored content is matched to the ad serving device. For example, the ad serving system 100 may search through the advertisement/sponsored content database 120 for advertisements and/or sponsored content that is related to the ad serving device and/or related to individuals in the vicinity of the ad serving device. For example, via the presence information described above, the ad serving system 100 may have ascertained that a particular individual likes dance clubs. Upon detecting the same individual in the vicinity of an ad serving device, the ad serving system 100 may locate advertisements and/or sponsored content related to dance clubs.

At block 525, the matched advertisements and/or sponsored content may be served to the ad serving device. For example, a dance club related advertisement may be served to the ad serving device. The reception of presence information, matching, and serving of the advertisements and/or sponsored content, may occur in real-time or at a later time as described above.

At block 530, an advertiser associated with the served advertisement and/or sponsored content may be charged according to a rate that may have been specified by the economic terms described above. The rate may be based on the economic terms specified by the owner of the ad serving device during registration. In one embodiment, the rate increases as the number of sensed individuals within the vicinity of the ad serving device increases. In another embodiment, the rate increases as the quality of the targets or the targeting itself increases. For example, the quality of the targeting may increase where an advertisement is targeted based on a rich set of data supporting the known characteristics and behaviors of the individuals in the vicinity of the ad serving device, whereas the quality of the target may be increased by either the demographic or income class of the user in general or for this specific instance and advertiser based upon supporting data that the user is already interested in the product or service being advertised. The reason for this is that this approach is more likely to result in a conversion or sale of the product being advertised. For example, if the search and communication histories of a user indicate that they have been researching new cars, then they would be a higher value and thus higher quality target for a car advertisement.

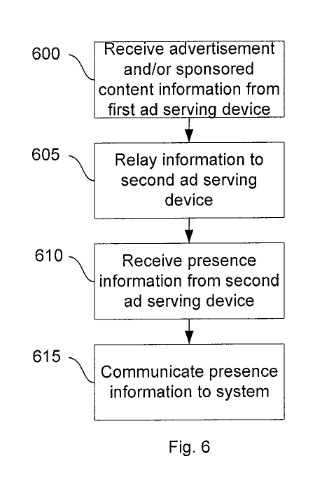

FIG. 6 is a flow diagram for serving advertisement and/or sponsored content via a proxy device. At block 600, the proxy device may receive the advertisement and/or sponsored content from a first ad serving device. As described above, the proxy device may include networking hardware and software, and a camera and/or microphone for receiving the advertisement and/or sponsored content from the first ad serving device. Advertisement identification information may be communicated to the proxy device as well. For example, the first ad serving device may communicate advertisement identifying information associated with the advertisement and/or sponsored content including economic terms to the proxy device. The proxy device may include a memory for storing the received advertisement and/or sponsored content.

At block 605, the proxy device may communicate the stored advertisement to a second ad serving device. At block 610, presence information may be received at the second ad serving device. At block 615, the presence information may be communicated to the ad serving system 100. For example, the second ad serving device may communicate the presence information directly to the ad serving system 100 or may communicate the presence information back to the proxy device, in which case the proxy device may communicate the presence information back to the ad serving system 100. Alternatively, the presence of individuals within the vicinity of the second ad serving device may be inferred if registered trackable devices are carried by the individuals.

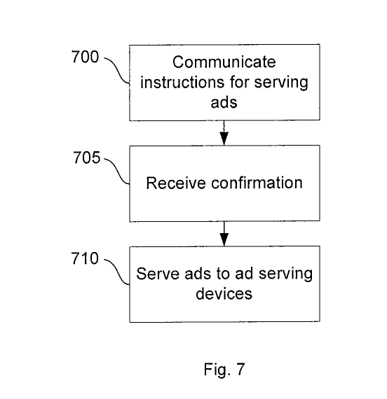

FIG. 7 is a flow diagram for serving advertisement and/or sponsored content to portable ad serving devices. In block 700, instructions may be communicated to an individual or individuals in possession of portable ad serving devices. The portable ad serving devices may have been registered previously according to block 500 of FIG. 5 above. The instructions may come by way of an SMS message to the portable ad serving device or an email to the owner of the portable ad serving device. The instructions may, for example, instruct the holder of the portable device to go to a particular place at a particular time with a particular association of users and/or to do a particular activity.

In some instances, instructions may be sent to several portable ad serving devices. This may be done to increase the effectiveness of the advertisement and/or sponsored content or to facilitate advertisement distribution, such as the distributed advertisement scenario described with reference to FIGS. 2C and 2D above. To facilitate advertisement distribution, instructions may be communicated from the ad serving system 100 to the owners of the portable devices instructing them to go a specified location at a specified time, alone or with others and engaged in a specific activity or not. The instructions may also direct the individuals to arrange themselves in a specified spatial order.

At block 705, a confirmation that the instructions have been followed may be received. The confirmation may be explicit or implicit. For example, the holder of the portable device may respond to the message as confirmation. Confirmation that the portable device is at the designated place at the designated time may also come by way of the presence information, as described above, as well as the confirmation of association or activity comes from co-presence and presence information. For example, the ad serving system 100 may verify that the portable device is at the designated location at the designated time via the location information described above, may verify the co-presence of other users via their GPS-enabled devices and verify that all users are jumping up and down from motion or biometric sensors also embedded within the devices.

At block 710, the ad serving system 100 may serve advertisements and/or sponsored content to the portable ad serving device. For example, in some instances, the same instructions may have been sent to more than one portable ad serving device. Upon receiving confirmation that all the portable ad serving devices are at the designated location, the ad serving system 100 may serve the advertisement and/or sponsored content to the several portable ad serving devices. The ad serving system 100 may distribute the advertisement and/or sponsored content across the portable ad serving devices, as shown in FIG. 2C. For example, the graphics may be distributed across the portable ad serving devices. Alternatively or in addition, an audio portion may be served to an ad serving device with audio capabilities, and the graphics may be served to an ad serving device with graphics capabilities. In some embodiments, the offer of downloadable content in response for satisfaction of the instructions by the users may be limited to only a specific number of users, types of users or other advertiser created limitation including a degraded version of the sponsored content being available for partial or late satisfaction.

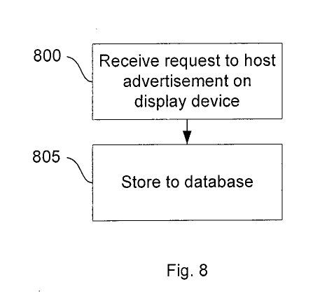

FIG. 8 is a flow diagram for enabling an owner of an ad serving device to register an ad serving device and, therefore, solicit the placement of advertisements. At block 800, the owner of the ad serving device may communicate a request to host advertisement and/or sponsored content on an ad serving device by registering the ad serving device with the ad serving system 100. For example, the ad serving system 100 may provide a registration request web page (not shown) with fields that enable registering the ad serving device, specifying preferences and economic terms and generally managing multiple ad displaying devices over time. Fields for specifying the type, dimensions and capabilities of the ad serving device, its location, when it can be used for serving advertisements or sponsored content and economic terms may be provided as well as fields for specifying actual or forecast data about the user traffic associated with the display device.

As said above, fields for specifying economic terms associated with the ad serving device may also be provided. The economic terms may be in monetary or non-monetary terms. A non-monetary example may correspond to free samples of products that are advertised on the ad serving device, reputation, ranking or territory “ownership” in a game or network currency, credits in mileage or reward points programs or network credit for products or services. A monetary example may correspond to a flat fee or variable rate for placing advertisement and/or sponsored content. In one embodiment, the rate may depend on the number of sensed individuals in the vicinity of the ad serving device when the advertisement is placed such that the price charged to the advertiser increases as the number of sensed individuals increases. This could be on a one-to-one scale increases and/or banded or tiered into traffic levels and agreed prices per impression for those levels. Economic terms may be resolved by actual data in real-time or upon forecasting using definable time periods and regular review of actual data upon which to regularly reforecast and thus re-evaluate the economic terms based upon available data. At block 805, the information may be stored. For example, the ad serving system 100 may store the received information in the device registration database 115.

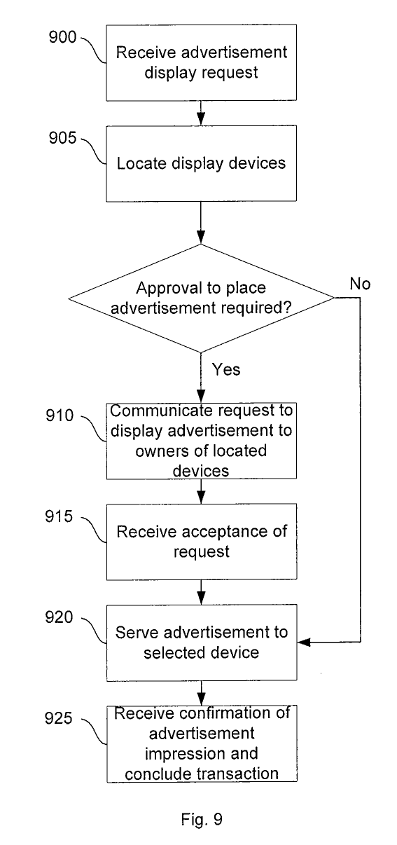

FIG. 9 is a flow diagram for enabling an advertiser to place advertisements on ad serving devices. At block 900, an advertiser may communicate a request to place an advertisement. For example, an ad request web page (not shown) may be generated by the ad serving system 100 and communicated to an advertiser terminal 130. Fields may be provided on the ad request web page that enable the advertiser to specify and target advertisements and/or sponsored content campaigns over time. For example, a field for uploading advertisement and/or sponsored content may be provided. The advertiser may also specify targeting information. For example, demographic and behavioral information related to a target audience may be specified. In addition, the targeting information may also enable targeting based on ad serving device location, ad serving device hours of availability, ad serving device traffic amount, and ad serving device type of traffic.

The web page may also enable specifying economic terms, such as a bid for placing an advertisement a CPM, CPC or CPA money amount, or other complex expressions of pricing based upon specific data or network conditions including the presence information provided by devices about the users present and co-present at particular display devices. Special instructions for displaying the advertisement and/or sponsored content may also be specified. These instructions may enable the advertiser to specify the time and/or place for serving the advertisement as well as conditions of co-presence of users and or topical or activity constraints on serving the advertiser wishes to specify. If a known sensor can test for the condition through the network, the advertiser can specify a specific value or value range for that condition as a condition for advertisement or sponsored content being served.

After specifying the information above, a list of candidate ad serving devices may be presented to the advertiser at block 905. The list may include economic terms specified by an owner of each ad serving device, their dimensions, capabilities and any known data on associated user traffic numbers and quality ratings. The advertiser may select ad serving devices by accepting the economic terms specified by the owner of the ad serving device and adding them as an authorized display device for that ad copy, sponsored content or campaign.

After selection, the advertisement specified above may be served to the ad serving device at block 920. In some instances, prior acceptance from the owner of the ad serving device may be necessary before an ad may be served. For example, the owner of a coffee house with an ad serving device in his store window may not want competitor advertisements shown on his ad serving device. In this case, at block 910, the request to place the advertisement may be communicated to the owner of an ad serving device. At block 915, the owner of the ad serving device may accept the ad placement. Then at block 920, the advertisement and/or sponsored content may be served to the ad serving device.

At block 925, presence information, as described above, may be communicated after the advertisement has been placed. The number of individuals sensed may be relevant where the economic terms specify a rate that is based on the number of individuals in the vicinity of the ad serving device. Once this is determined, the device owner is compensated according to the economic terms specified. In some cases, monetary funds may be distributed among the owner of the ad serving device, the ad serving device carrier network provider, and/or the owner of the ad serving system.

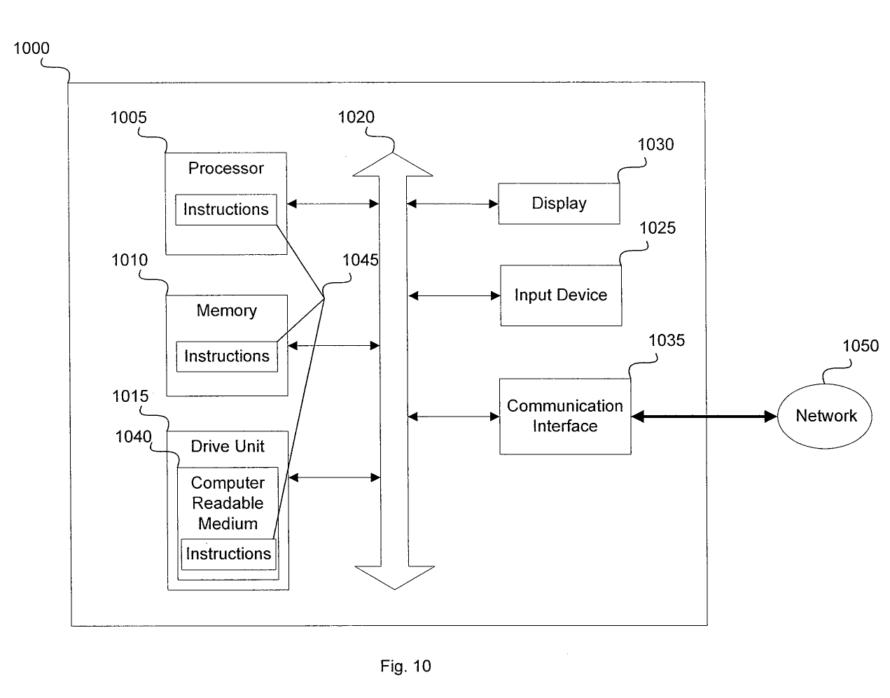

FIG. 10 illustrates a general computer system, which may represent the processor 105 of FIG. 1, the ad serving devices 200 of FIG. 2A, the trackable devices 300 of FIG. 3, the proxy devices 400 of FIG. 4, or any of the other computing devices referenced herein. The computer system 1000 may include a set of instructions 1045 that may be executed to cause the computer system 1000 to perform any one or more of the methods or computer based functions disclosed herein. The computer system 1000 may operate as a stand-alone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1045 (sequential or otherwise) that specify actions to be taken by that machine. In one embodiment, the computer system 1000 may be implemented using electronic devices that provide voice, video or data communication. Further, while a single computer system 1000 may be illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1005, such as a central processing unit (CPU), a graphics processing unit (GPU), or both. The processor 1005 may be a component in a variety of systems. For example, the processor 1005 may be part of a standard personal computer or a workstation. The processor 1005 may be one or more general processors, digital signal processors, application specific integrated circuits, field programmable gate arrays, servers, networks, digital circuits, analog circuits, combinations thereof, or other now known or later developed devices for analyzing and processing data. The processor 1005 may implement a software program, such as code generated manually (i.e., programmed).

The computer system 1000 may include a memory 1010 that can communicate via a bus 1020. For example, the device tracking database 110, device registration database 115, and/or advertisement/sponsored content database 120 of FIG. 1 may be stored in the memory. The memory 1010 may be a main memory, a static memory, or a dynamic memory. The memory 1010 may include, but may not be limited to, computer readable storage media such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one case, the memory 1010 may include a cache or random access memory for the processor 1005. Alternatively or in addition, the memory 1010 may be separate from the processor 1005, such as a cache memory of a processor, the system memory, or other memory. The memory 1010 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1010 may be operable to store instructions 1045 executable by the processor 1005. The functions, acts or tasks illustrated in the figures or described herein may be performed by the programmed processor 1005 executing the instructions 1045 stored in the memory 1010. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1000 may further include a display 1030, such as a liquid crystal display (LCD), an organic light emitting diode (OLED), a flat panel display, a solid state display, a cathode ray tube (CRT), a projector, a printer or other now known or later developed display device for outputting determined information. The display 1030 may act as an interface for the user to see the functioning of the processor 1005, or specifically as an interface with the software stored in the memory 1010 or in the drive unit 1015.

Additionally, the computer system 1000 may include an input device 1025 configured to allow a user to interact with any of the components of system 1000. The input device 1025 may be a number pad, a keyboard, or a cursor control device, such as a mouse, or a joystick, touch screen display, remote control or any other device operative to interact with the system 1000.

The computer system 1000 may also include a disk or optical drive unit 1015. The disk drive unit 1015 may include a computer-readable medium 1040 in which one or more sets of instructions 1045, e.g. software, can be embedded. Further, the instructions 1045 may perform one or more of the methods or logic as described herein. The instructions 1045 may reside completely, or at least partially, within the memory 1010 and/or within the processor 1005 during execution by the computer system 1000. The memory 1010 and the processor 1005 also may include computer-readable media as discussed above.

The present disclosure contemplates a computer-readable medium 1040 that includes instructions 1045 or receives and executes instructions 1045 responsive to a propagated signal; so that a device connected to a network 1050 may communicate voice, video, audio, images or any other data over the network 1050. The instructions 1045 may be implemented with hardware, software and/or firmware, or any combination thereof. Further, the instructions 1045 may be transmitted or received over the network 1050 via a communication interface 1035. The communication interface 1035 may be a part of the processor 1005 or may be a separate component. The communication interface 1035 may be created in software or may be a physical connection in hardware. The communication interface 1035 may be configured to connect with a network 1050, external media, the display 1030, or any other components in system 1000, or combinations thereof. The connection with the network 1050 may be a physical connection, such as a wired Ethernet connection or may be established wirelessly as discussed below. Likewise, the additional connections with other components of the system 1000 may be physical connections or may be established wirelessly.

The network 1050 may include wired networks, wireless networks, or combinations thereof. The wireless network may be a cellular telephone network, an 802.11, 802.16, 802.20, or WiMax network. Further, the network 1050 may be a public network, such as the Internet, a private network, such as an intranet, or combinations thereof, and may utilize a variety of networking protocols now available or later developed including, but not limited to, TCP/IP based networking protocols.

The computer-readable medium 1040 may be a single medium, or the computer-readable medium 1040 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1040 may include a solid-state memory such as a memory card or other package that houses one or more non-volatile read-only memories. The computer-readable medium 1040 also may be a random access memory or other volatile re-writable memory. Additionally, the computer-readable medium 1040 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the methods described herein and which, when loaded in a computer system, is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

From the foregoing, it may be seen that the embodiments disclosed herein provide an approach for serving advertisement and/or sponsored content. For example, ad serving device owners may register their respective ad serving devices with the ad serving system while advertisers may upload and target advertisement and/or sponsored content to those registered ad serving devices. The ad serving system matches advertiser requests for placing the advertisement and/or sponsored content to ad serving devices that meet the advertiser's specified request. Advertisers may be charged at a rate that may be dependent on the number of individuals within the vicinity of the ad serving device at the time the advertisement and/or sponsored content is placed as well as the co-presence and activities of users. The presence of individuals may be determined via trackable devices carried by the individuals and present in their environments. The trackable device may communicate location information to the ad serving system either through environmental sensors, the ad serving device or directly via a different network, such as a carrier network. The system continually tracks the location and activity of an individual so as to determine characteristics and behaviors of the individual. This in turn enables more effective targeting of advertisement and/or sponsored content.

In one embodiment, advertisement and/or sponsored content may be distributed across several ad serving devices. To facilitate the distribution, instructions may be sent to owners of the ad serving devices instructing them where to go and when to go, whom to go with and what, if anything, they need be doing. Upon receiving confirmation that the device owners are at the specified place at the specified time, the ad serving system may serve advertisements or sponsored content to the ad serving devices. The same advertisement and/or sponsored content may be displayed on all of the devices or alternatively partitioned among the devices. For example, an audio portion of an advertisement may be communicated to an ad serving device with audio capabilities, while the graphical portion of the advertisement may be communicated to an ad serving device with graphics capabilities.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for serving advertisement or sponsored content information, the method comprising:
receiving first ad serving device information;
receiving presence information corresponding to a sensed presence of individuals in a vicinity of the first ad serving device;
matching the first ad serving device information and presence information to advertisement or sponsored content information; and
serving the advertisement or sponsored content information to the first ad serving device.

2. The method according to claim 1, wherein receiving presence information, matching, and serving of the advertisement or sponsored content information occur in substantially real-time.

3. The method according to claim 1, wherein the first ad serving device corresponds to at least one of: a portable device, and a fixed device.

4. The method according to claim 1, wherein the first ad serving device information includes first ad serving device capabilities.

5. The method according to claim 1, wherein receiving presence information further comprises receiving information associated with portable devices carried by the individuals.

6. The method according to claim 5, wherein the received information corresponds to at least one of: GPS based location information, network based location information, and data communicated between the portable devices and the first ad serving device.

7. The method according to claim 5, wherein the received information includes portable device identifying information that is unique to each of the portable devices.

8. The method according to claim 7, further comprising determining a behavior of the individuals in possession of the portable devices and serving advertisement or sponsored content information related to the determined behavior.

9. The method according to claim 7, wherein the portable device identifying information is associated with a first individual.

10. The method according to claim 9, further comprising:
determining characteristics corresponding to at least one of: demographics and behaviors associated with the first individual; and
serving advertisement or sponsored content information that matches the determined characteristics when the first individual is sensed in the vicinity of the first ad serving device.

11. The method according to claim 10, further comprising:
sensing a second individual in the vicinity of the portable device at a same time as the first individual, the first individual and second individual having a known relatedness to one another; and
serving advertisement or sponsored content information to the first ad serving device based on the known relatedness.

12. The method according to claim 1, further comprising receiving presence information corresponding to a sensed presence of individuals in a vicinity of a second ad serving device, where the second ad serving device serves advertisement or sponsored content information relayed from the first ad serving device via a proxy device.

13. The method according to claim 12, wherein the advertisement or sponsored content information is stored to either the proxy device or the second ad serving device and served at the second ad serving device at a later time, where the presence information is received at the later time.

14. The method according to claim 12, further comprising transcoding the advertisement or sponsored content information to fit capabilities of the second ad serving device.

15. The method according to claim 1, further comprising receiving presence information corresponding to a sensed presence of individuals in the vicinity of a second ad serving device serving a stored version of the advertisement or sponsored content information, the advertisement or sponsored content information having been previously communicated to the second ad serving device from the first ad serving device.

16. The method according to claim 1, further comprising communicating a rate amount associated with serving advertisement or sponsored content information to the first ad serving device.

17. The method according to claim 16, wherein the rate amount increases in relation to a sensed number of individuals within the vicinity of the first ad serving device increases.

18. The method according to claim 17, wherein the rate amount increases with a quality rating associated with individuals within the vicinity of the first ad serving device.

19. The method according to claim 17, wherein the quality rating corresponds to at least one of: a demographic match, targeting match, and a conversion probability.

20. A machine-readable storage medium having stored thereon a computer program comprising at least one code section for serving advertisement or sponsored content information, the at least one code section being executable by a machine for causing the machine to perform acts of:
receiving first ad serving device information;
receiving presence information corresponding to a sensed presence of individuals in a vicinity of the first ad serving device;
matching the first ad serving device information and presence information to an advertisement or sponsored content information; and
serving the advertisement or sponsored content information to the first ad serving device, wherein receiving presence information, matching, and serving of the advertisement or sponsored content information occur in substantially real-time.

21. The machine-readable storage according to claim 20, wherein the at least one code section comprises code that enables receiving information associated with portable devices carried by the individuals, wherein the received information corresponds to at least one of: GPS based location information, network based location information, and data communicated between the portable devices and the first ad serving device.

22. The machine-readable storage according to claim 20, further comprising:
determining characteristics corresponding to at least one of: demographics and behaviors associated with a first individual; and
serving advertisement or sponsored content information that matches the determined characteristics when the first individual is sensed in the vicinity of the first ad serving device.

23. A system for serving advertisement or sponsored content information, the system comprising:
a processor with circuitry operable to receive first ad serving device information and receive presence information corresponding to a sensed presence of individuals in a vicinity of the first ad serving device; and
circuitry operable to match the first ad serving device information and presence information to advertisement or sponsored content information and serve the advertisement or sponsored content information to the first ad serving device, wherein receiving presence information, matching, and serving of the advertisement or sponsored content information occur in substantially real-time.

24. The system according to claim 23, further comprising circuitry operable to receive information associated with portable devices carried by the individuals, wherein the received information corresponds to at least one of: GPS based location information, network based location information, and data communicated between the portable devices and the first ad serving device.

25. The system according to claim 23, further comprising circuitry operable to determine characteristics corresponding to at least one of: demographics and behaviors associated with a first individual and operable to serve advertisements or sponsored content information that match the determined characteristics when the first individual is sensed in the vicinity of the first ad serving device.
